(19) United States
(12) Patent Application Publication
(10) Pub. No.: US 2023/0151794 A1
(43) Pub. Date: May 18, 2023

(54) WIND TURBINE ROTOR BLADE

(71) Applicant: Wobben Properties GmbH, Aurich (DE)

(72) Inventors: Muhanad Mahmoud, Aurich (DE); Jochen Stemberg, Aurich (DE); Hussam Daboul, Sudbrookmerland (DE)

(21) Appl. No.: 18/055,231

(22) Filed: Nov. 14, 2022

(30) Foreign Application Priority Data
Nov. 16, 2021 (WO) 21208379.4

(51) Int. Cl. F03D 1/06

(52) U.S. Cl. CPC F03D 1/0683; F05B 2240/301

(57) ABSTRACT

Provided is a wind turbine rotor blade with a rotor blade shell, which envelops an internal volume, and at least one vortex generator in the internal volume.

### BACKGROUND

### Technical Field

The present invention relates to a wind turbine rotor blade.

### Description of the Related Art

Since the rotor blades of a wind turbine are exposed to all weather conditions without protection, the rotor blades can become iced over at certain temperatures. In order to prevent this, use can be made of a rotor blade heater. Either a heater can here be provided outside on the rotor blade, or heated air can be provided inside of the rotor blade.

A rotor blade heater is often used to prevent the rotor blades from icing over. Heater air is here typically introduced into the interior of the rotor blade in the area of the rotor blade root. The heated air in turn heats up the rotor blade shell, for example in the area of the rotor blade nose, so that a deicing of the rotor blade can be achieved.

WO 2017/021350 A1 shows a wind turbine rotor blade with a rotor blade root area and a rotor blade tip area and a rotor blade heater. Also provided is at least one web along a longitudinal direction of the rotor blade. A deflection unit for deflecting the air can be provided on the web.

WO 2018/211055 shows a rotor blade of a wind turbine, which has a web and a deflection unit on the rotor blade tip for deflecting heated air.

### BRIEF SUMMARY

Provided is a wind turbine rotor blade with an improved rotor blade heater.

More particularly, provided is a wind turbine rotor blade with a rotor blade shell that envelops an internal volume, and has at least one vortex generator in the internal volume. By providing the vortex generators in the internal volume (e.g., on the interior side of the rotor blade shell), the air flow inside of the rotor blade shell can be improved, which leads to an improved heat transfer, and thus to an improved heating of the rotor blades.

According to an aspect of the invention, first vortex generators are provided on an interior side of the rotor blade shell.

According to an aspect of the present invention, the rotor blade has at least one web along a longitudinal direction of the rotor blade. At least one vortex generator can be arranged on the at least one web, or fastened with the web.

According to another aspect of the present invention, the rotor blade has at least one first and second web along a longitudinal direction of the rotor blade. Further provided is a first air channel between a front edge of the rotor blade and a first web, wherein at least one vortex generator is provided in the first air channel.

According to another aspect of the present invention, the rotor blade has a second air channel between a web and a rotor blade trailing edge. At least one vortex generator is provided at least partially in the second air channel along the longitudinal direction of the rotor blade.

According to another aspect of the present invention, the rotor blade has a least one vortex generator in a third air channel between the first and second webs.

According to another aspect of the present invention, the rotor blade has a rotor blade heating system in or on the root of the rotor blade. The rotor blade heating system generates warm air, which is conveyed into the internal volume of the rotor blade.

Provided is a wind turbine with at least one wind turbine rotor blade described above.

Mounting vortex generators on the interior side of the rotor blade shell and/or on the webs makes it possible to improve the heat transfer of the heated air to the rotor blade shell. Due to the geometry of the vortex generators, providing the vortex generators inside of the rotor blade does not result in a significant pressure loss. This is because the wall pressure loss depends primarily on the normal gradient of the velocity component along the primary direction of flow on the wall, and not on the gradient of the velocity component of the secondary flow.

Thus provided is a wind turbine rotor blade with a (two-part) blade shell, which envelops an internal volume. The rotor blade further has a rotor blade root and a rotor blade tip. At least one web can be provided at least sectionally between the two blade shells along a longitudinal direction of the rotor blade, so that the internal volume of the rotor blade is divided into at least two sections. The rotor blade further has a rotor blade heater, for example which is provided in the area of the rotor blade root, and conveys heated air into the internal volume of the rotor blade. To improve the effectiveness of the blade heater, at least one vortex generator is provided in the internal volume. The more uniform mixing of the flow caused by the vortex generators leads to an improved heat transfer to the rotor blade shells, so that an improved rotor blade heater can be achieved by providing the vortex generators.

According to an aspect of the present invention, a web is provided between the two blade shells (pressure side, suction side), so that an air channel comes about in the area of the rotor blade front edge, through and along which the air heated by the rotor blade heater can flow. At least one first vortex generator is provided in the area of the first channel, at least partially along a longitudinal axis of the rotor blade.

According to another aspect of the present invention, a second web is provided between the two rotor blade shells, so that a second channel arises in the area of the rotor blade trailing edge. An optional second vortex generator can be provided in this second channel.

According to an aspect of the present invention, a third channel can be provided at least partially between the first and second webs. Third vortex generators can optionally be provided in the third channel.

Providing the vortex generators in the internal volume of the rotor blade mixes the flow, which leads to a more uniform temperature distribution. This results in an increase in the heat transfer coefficient α.

In addition to the vortex generators, cross sectional constrictions can be provided inside of the rotor blades. A change in the blade internal flow takes place to improve a heat transfer of the heated air from the blade heater to the rotor blade shell. The cross sectional constrictions represent passive options for increasing the flow rate.

According to an aspect of the invention, the vortex generators and the cross sectional constrictions can be installed retroactively.

Additional configurations are the subject of the subclaims.

### BRIEF DESCRIPTION OF THE SEVERAL VIEWS OF THE DRAWINGS

Advantages and exemplary embodiments of the invention will be explained in more detail below with reference to the drawing.

FIG. 1 shows a schematic view of a wind turbine according to the invention,

FIG. 2A show a schematic cross section and a schematic and 2B longitudinal section of a rotor blade according to prior art,

FIG. 3A shows a schematic cross section of a rotor blade according to an aspect of the invention, and

FIG. 3B shows a schematic longitudinal section of a rotor blade according to FIG. 3A.

### DETAILED DESCRIPTION

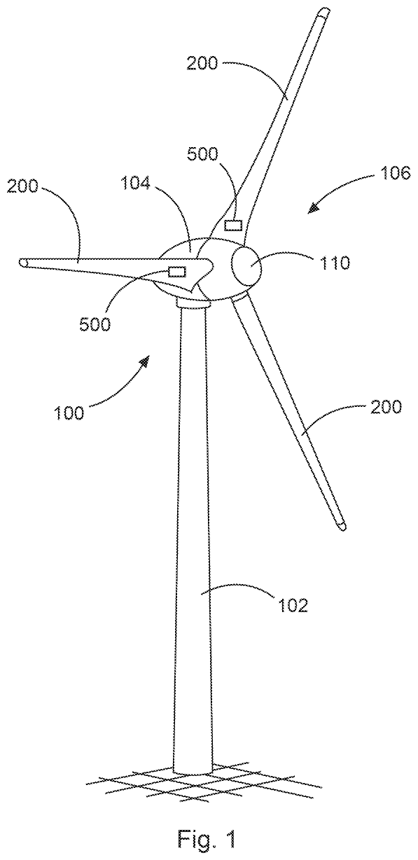

FIG. 1 shows a schematic view of a wind turbine according to the invention. The wind turbine 100 has a tower 102 and a nacelle 104 on the tower 102. Provided on the nacelle 104 is an aerodynamic rotor 106 with three rotor blades 200 and a spinner 110. During operation of the wind turbine, the wind imparts a rotational motion to the aerodynamic rotor 106, which thus also turns a rotor or runner of a generator, which is directly or indirectly coupled with the aerodynamic rotor 106. The electric generator is arranged in the nacelle 104, and generates electric energy. The pitch angles of the rotor blades 200 can be changed by pitch motors on the rotor blade roots of the respective rotor blades 200.

A rotor blade heater 500 can be provided in the area of a rotor blade root for purposes of rotor blade deicing. As an alternative thereto, the rotor blade heater 500 can be provided in an area of a rotor hub or on a rotor blade connector. The rotor blade heater 500 generates hot air, and then conducts it into the interior of the rotor blade to deice the rotor blade or prevent icing.

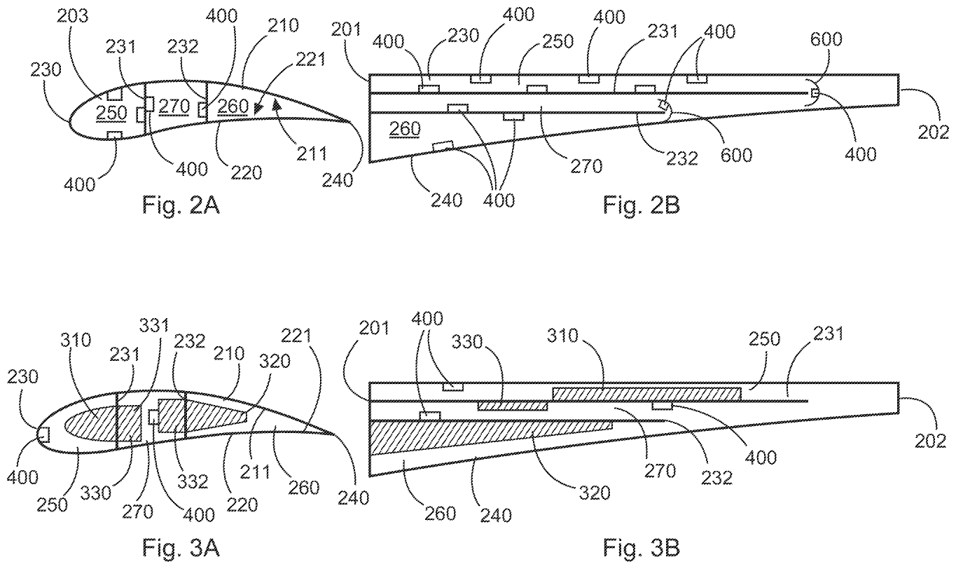

FIG. 2A shows a cross section of a rotor blade, and FIG. 2B shows a longitudinal section of a rotor blade. The rotor blade 200 has two blade shells 210, 220 each having an interior side 211, 221, which envelop an internal volume 203. The rotor blade 200 further has a rotor blade leading edge 230 and a rotor blade trailing edge 240. Webs 231, 232 can be provided between the blade shells 210, 220, so that the internal volume 203 can be divided into various portions or channels 250, 260 and 270 (first channel 250 between the leading edge 230 and first web 231, second channel 260 between the trailing edge 240 and second web 232, and third channel 270 between the first and second webs 231, 232). For example, the web 231 can be longer than the web 232.

Deflecting arcs 600 can optionally be provided at the free end of the webs. According to an aspect of the present invention, vortex generators can be provided in or on the deflecting arc.

At least one vortex generator 400 can be provided inside of the rotor blade, i.e., on the interior side of the rotor blade shells and/or on the webs 231, 232. The vortex generator 400 can be placed in the entire internal volume of the rotor blade. For example, the vortex generators 400 can be placed in the first, second or third channel 250, 260, 270 on the interior sides 211, 221 of the rotor blade shells 210, 220 and/or on the webs 231, 232. Providing the vortex generators 400 makes it possible to positively influence the air flow inside of the rotor blade. In particular, turbulences can be generated. As a result, a heat transfer of heated air generated by the rotor blade heater 500 to the rotor blade shells can be improved.

Several vortex generators 400 can be provided along the length of the rotor blade 200.

FIGS. 3A and 3B show a corresponding cross section of a rotor blade as well as a longitudinal section of the rotor blade according to an exemplary embodiment of the invention. While the channels 250, 260 and 270 with the vortex generators 400 are shown unchanged in the rotor blade according to FIG. 2A and 2B, at least portions of the channels according to FIGS. 3A and 3B are provided with cross sectional constrictions 310 in the first channel 250, with second cross sectional constrictions 320 in the second channel 260 and/or optionally with third cross sectional constrictions 330 in the third channel 270. In addition to the vortex generators 400, cross sectional constrictions 300 can thus be provided.

FIG. 3B shows the distribution of the cross sectional constrictions 310, 320, 330 along a longitudinal axis of the rotor blade.

Both the cross sections of the cross sectional constrictions and their distribution along the longitudinal axis of the rotor blade can differ from the cross sections and longitudinal distributions shown on FIGS. 3A and 3B.

The cross sectional constrictions result in a higher flow rate of the air flowing through the rotor blade heater 500 into the interior (into the channels 250, 260, 270) of the rotor blade.

The cross sectional constrictions in combination with the vortex generators can help improve the rotor blade heater.

### REFERENCE LIST

100 Wind turbine

102 Tower

104 Nacelle

106 Rotor

110 Spinner

200 Rotor blades

203 Internal volume

210 Blade shells

211 Blade shell interior side

220 Blade shells

221 Blade shell interior side

230 Rotor blade leading edge

231 Webs

232 Webs

240 Rotor blade trailing edge

250 Channels

260 Channels

270 Channels

300 Cross sectional constriction

310 Cross sectional constrictions

320 Cross sectional constrictions

330 Cross sectional constrictions

400 Vortex-generator

500 Rotor blade heater

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wind turbine rotor blade, comprising:
a rotor blade shell that envelops an internal volume, and
a first vortex generator in the internal volume.

2. The wind turbine rotor blade according to claim 1, comprising a plurality of second vortex generators arranged on an interior surface of the rotor blade shell and in the internal volume.

3. The wind turbine rotor blade according to claim 2, comprising:
at least one web in the internal volume and extending along a longitudinal direction of the rotor blade,
a plurality of third vortex generators arranged on the at least one web.

4. The wind turbine rotor blade according to claim 1, comprising:
first and second webs in the internal volume and extending along a longitudinal axis of the rotor blade, and
a first air channel between a leading edge of the rotor blade and the first web,
a second vortex generator in the first air channel.

5. The wind turbine rotor blade according to claim 4, comprising:
a second air channel between a web and a rotor blade trialing edge,
a third vortex generator arranged at least partially in the second air channel along the longitudinal direction of the rotor blade.

6. The wind turbine rotor blade according to claim 4, comprising:
a third vortex generator in a third ventilation channel between the first and second webs.

7. The wind turbine rotor blade according to claim 1, further comprising a rotor blade heating system at a rotor blade root of the wind turbine rotor blade, wherein the rotor blade heating system is configured to generate heated air, and convey the heated air into the internal volume of the rotor blade.

8. The wind turbine rotor blade according to claim 1, further comprising a cross sectional constriction for narrowing a free cross section of the internal volume.

9. A wind turbine comprising:
a tower,
an aerodynamic rotor, and
the wind turbine rotor blade according to claim 1 coupled to the aerodynamic rotor.

10. The wind turbine according to claim 9, further comprising:
a rotor blade heating system configured to generate heated air and convey the heated air into the internal volume of the rotor blade.
